(19) United States
(12) Patent Application Publication
(10) Pub. No.: US 2026/0208614 A1
(43) Pub. Date: Jul. 23, 2026

(54) METHOD FOR PAIRING A CHARGING POINT FOR AN ELECTRIC VEHICLE HAVING A NETWORK OF AT LEAST ONE CHARGING POINT, ASSOCIATED NETWORK AND METHOD FOR MANAGING THE ENERGY OF SUCH A NETWORK OF CHARGING POINTS

(71) Applicant: AMPERE S.A.S., Boulogne Billancourt (FR)

(72) Inventors: Guillaume DEMOND, Guyancourt Cedex (FR); Didier DERUY, Guyancourt Cedex (FR); Guy-William PIVOT, Guyancourt Cedex (FR)

(73) Assignee: AMPERE S.A.S., Boulogne Billancourt (FR)

(21) Appl. No.: 19/140,614

(22) PCT Filed: Dec. 1, 2023
(86) PCT No.: PCT/EP2023/083987

§ 371 Date: Aug. 15, 2025

(30) Foreign Application Priority Data
Dec. 22, 2022 (FR) FR2214278

(51) Int. Cl. B60L 53/67; B60L 53/30; H04W 4/44

(52) U.S. Cl. CPC B60L 53/67; B60L 53/30; H04W 4/44

(57) ABSTRACT

A method is provided for pairing a charging terminal for charging an electric vehicle or a repeater with a communication network of at least one charging terminal. The method includes installing the charging terminal to be paired in a geographical area around a charging terminal of the network with a radius smaller than a predefined maximum distance between two charging terminals of the network, supplying energy to the charging terminal to be paired, activating a first operating mode on a first terminal of the network, activating the first operating mode of the other terminals of the network, activating the first operating mode on the charging terminal to be paired during the activation of the first operating mode on the first terminal of the network, and pairing the terminal to be paired and the terminals of the network.

### TECHNICAL FIELD

The invention relates in general to the management of a station of charging terminals for electric and/or hybrid vehicles.

The invention relates more specifically to the formation of a communication network between the terminals of a station.

The invention relates more particularly to a method for pairing a new charging terminal with a network of one or more charging terminals of one and the same station.

### PRIOR ART

Over the past few years, electric and hybrid vehicles have become increasingly prevalent in the motor vehicle sector, and have become widespread.

This means that an ever-increasing number of such vehicles are liable to be on the road, be this in towns and cities or outside urban areas.

These vehicles, which operate using electrical energy stored in batteries, periodically require these batteries to be charged.

This charging is carried out by connecting the vehicle to a charging terminal that is connected to an electrical source.

Like petrol stations for combustion vehicles, stations comprising a large number of electric charging terminals are thus deployed in territories in order to meet the increasing demands of drivers.

Within a station, the terminals need to communicate with one another and/or with a station management center. The station management center is for example an industrial computer or a programmable logic controller installed locally at the station in order in particular to locally supervise the charging terminals and/or to perform local energy management for the station.

As things stand, the terminals of a station are each connected in wired fashion to a network switch, which is itself connected to a gateway providing Internet access such as a modem, the terminals also being connected in wired fashion to the local station management center.

This architecture involves numerous drawbacks. Indeed, a large amount of wiring is needed, and the architecture requires the installation of a local control cabinet to house in particular the network switch and the Internet gateway. Moreover, this architecture requires a network configuration using the Internet protocol suite, referred to as TCP/IP, which may prove expensive and complex to put in place. Furthermore, this architecture makes it difficult to add an additional terminal to the station.

Moreover, since such an architecture is locally centralized, a single failure in the central node, formed in particular by the modem, may make the entire station unusable.

Finally, this architecture involves significant coupling between the software and the providers of the charging terminals, on the one hand, and the management center, on the other hand.

The present invention therefore aims to overcome the abovementioned drawbacks and to propose a method for pairing a charging terminal with a network of terminals of a station, and an improved corresponding network.

The present invention thus relates to a method for pairing a charging terminal for charging an electric vehicle or a repeater with a communication network of at least one charging terminal, comprising the following steps:
Installing the charging terminal to be paired in a geographical area around a charging terminal of the network with a radius smaller than a predefined maximum distance between two charging terminals of the network,
Supplying energy to the charging terminal to be paired,
Activating a first operating mode on a first terminal of the network, the first mode remaining activated for a predefined duration,
The first terminal of the network issuing an order to activate the first operating mode to the other terminals of the network, if the network comprises other charging terminals,
Activating the first operating mode of the other terminals of the network after receipt of the activation signal,
The terminals of the network transmitting a signal concerning activation of the first operating mode,
Activating the first operating mode on the charging terminal to be paired during the activation of the first operating mode on the first terminal of the network,
Pairing the terminal to be paired and the terminals of the network, the pairing being carried out during the activation of the first mode on all of the terminals of the network and the terminal to be paired.

Advantageously, the paired terminals are configured to detach from the network in a second operating mode.

Preferably, the pairing of a repeater with the network is identical to the pairing of a charging terminal.

Advantageously, the predefined duration is 5 to 10 seconds.

Preferably, the activation signal is an acoustic signal or a light signal.

Advantageously, the predefined maximum distance between two charging terminals of the network is ten to fifteen meters.

The invention also relates to a communication network between one or more electric charging terminals, the terminals being paired with one another in accordance with the method defined above, the network being a meshed network.

The invention also relates to a method for managing energy delivered by a charging terminal of a station of charging terminals for electric vehicles, the terminals of the station being paired in accordance with the method defined above and forming a communication network as defined above, comprising the following steps:
Defining an initial configuration of energy management parameters,
Communicating the initial configuration to all of the terminals of the station via the network,
Each terminal of the network locally storing the initial configuration,
Connecting or disconnecting an electric vehicle to or from a first terminal of the station,
Determining a requirement in terms of power to be delivered from the first terminal,
The first terminal recovering energy usage data from the other terminals of the station via the network,
Determining a power available to be delivered by the first terminal on the basis of: the determined requirement in terms of power to be delivered, the recovered energy usage data and the defined initial configuration,
Determining a corrected power to be delivered, to be applied by each of the other terminals of the station delivering power, n the basis of the determined power available to be delivered by the first terminal, the recovered energy usage data and the defined initial configuration,
The other terminals of the station recovering their corrected power to be delivered and the power available to be delivered by the first terminal,
The other terminals of the station applying their recovered corrected power to be delivered,
Transmitting, to the first terminal, a confirmation of application of the corrected power to be delivered by each of the other terminals of the station,
The first terminal charging the electric vehicle on the basis of the determined power available to be delivered.

Advantageously, the energy management parameters forming the initial configuration comprise a type of power setpoint to be delivered by each of the terminals and an energy access priority management protocol for the terminals of the station.

Preferably, the type of power setpoint to be delivered is static or dynamic.

### BRIEF DESCRIPTION OF THE DRAWINGS

Other aims, features and advantages of the invention will become apparent upon reading the following description, which is given solely by way of non-limiting example and with reference to the appended drawings, in which:

FIG. 1 schematically illustrates a station of charging terminals for electric and/or hybrid vehicles and a network according to the invention;

FIG. 2 illustrates a method for pairing a charging terminal with the network of terminals of the station of FIG. 1 according to the invention;

FIG. 3 illustrates a method for managing energy delivered by a terminal of the station according to the invention.

### DETAILED DESCRIPTION OF AT LEAST ONE EMBODIMENT

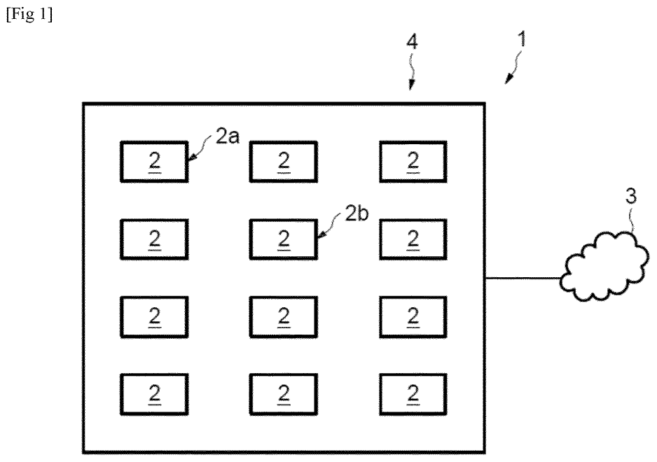

FIG. 1 schematically shows a charging station 1 for electric vehicles. The station 1 thus comprises one or more charging terminals 2 for electric vehicles, which are each supplied with energy from an energy reserve 3 of the station 1.

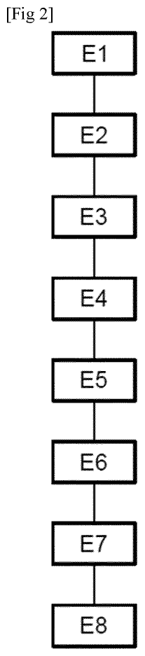

The charging terminals 2 are paired with one another in accordance with a pairing method illustrated schematically in FIG. 2, so as to form a communication network 4 with one another. The pairing method will be described below, taking the pairing of a new terminal 2a that has not yet paired with the network 4 as an illustrative example.

The terminal 2a to be paired is identical to the terminals 2 that have already paired and form the network 4, and so the following description of each of the terminals 2 of the network 4 is applicable to the terminal 2a to be paired.

Each of the charging terminals 2 of the network 4 is configured to communicate with remote objects or servers using telecommunications techniques.

In particular, each of the terminals 2 is configured to communicate with these remote objects or servers using medium-range wireless telecommunications techniques involving distances of the order of 10 to 20 meters. Preferably, the terminals 2 use the BLE telecommunications protocol, BLE standing for Bluetooth Low Energy.

As an alternative, the terminals 2 may also use the Bluetooth protocol. In other words, each of the terminals 2 is configured to communicate with remote objects located a medium distance away and able to communicate on the 2.4 GHz frequency band.

In particular, each of the charging terminals 2 is configured for medium-range communication with another, identically configured terminal 2. Each charging terminal 2 is therefore able to communicate with another charging terminal 2 using a common medium-range wireless telecommunications protocol involving distances of the order of 10 to 20 meters, such as Bluetooth Low Energy or Bluetooth.

Each of the terminals 2 is configured to operate in a first operating mode, referred to as pairing mode, and in a second operating mode, referred to as unpairing mode.

More specifically, in the first operating mode, referred to as pairing mode, a terminal 2 is able to pair with another terminal 2 also operating in the first operating mode and/or with a network of terminals 2 the terminals of which are also operating in the first operating mode.

In other words, a terminal 2 that has already paired with the network 4 and is operating in the first mode is able to detect a new terminal 2a that has not yet paired with the network 4 and is itself also operating in the first operating mode, and to pair this new terminal 2a with the network 4.

Correspondingly, a new terminal 2a that has not paired with the network 4 and is operating in the first operating mode is able to be paired with the network 4 of at least one terminal 2 operating in the first operating mode.

The simultaneous activation of the first operating mode of two terminals 2 and 2a that have not yet paired and are located at a communication distance from one another therefore brings about pairing of the two terminals 2 with one another. Likewise, the simultaneous activation of the first operating mode of the terminals 2 of the network 4 and of a terminal 2a that has not yet paired with the network 4 brings about pairing of the new terminal 2a with the network 4.

The first operating mode is activated by way of a non-publicly accessible switching means of the station 1, such as a button.

When the switching means of terminal 2 is activated, the terminal 2 starts operating in the first operating mode. The first mode of a terminal 2 is activated continuously for a predefined duration starting from the activation of the switching means, so as to leave enough time to allow the first mode to be activated on the one or more other terminals with which it is desired to pair said terminal 2.

For example, the predefined duration is 30 to 80 seconds, and preferably 60 seconds.

When the predefined duration has expired, the first operating mode is deactivated, and a terminal 2 is no longer able to pair and to be paired with a network.

In the second operating mode, referred to as unpairing mode, a terminal 2 that has already paired with the network 4 may unpair from the network 4, that is to say a terminal 2 operating in the second operating mode is configured to detach from a terminal 2 and/or from a network 4 of terminals with which it was previously paired.

FIG. 2 schematically illustrates the steps of a method for pairing a new charging terminal 2a with the network 4 of at least one charging terminal 2. As described above, the new charging terminal 2a is substantially identical to the other terminals 2. In other words, the terminal 2a to be paired is configured to operate in the first operating mode, referred to as pairing mode, and in the second operating mode, referred to as unpairing mode. Moreover, the terminal 2a to be paired is also configured for medium-range communication with another, identically configured terminal 2.

In a first step E1, the charging terminal 2a to be paired is installed in a geographical area delimited by a predefined radius around a terminal 2 that has already paired with the network 4. If the terminal 2a is the first terminal to be paired, that is to say the network comprises only a single terminal 2, step El consists in installing the terminal 2a to be paired in a geographical area around the terminal 2.

The predefined radius delimiting the geographical area is defined by the maximum distance permitted by the telecommunications protocol used jointly by the charging terminals 2 to communicate with one another. The predefined radius is thus between 10 and 20 meters, corresponding to the range of a communication between two objects using a medium-range wireless communication protocol.

The terminal 2a is therefore installed for example 10 meters away from one of the terminals 2 of the network 4.

During installation thereof, the terminal 2a is connected to the energy reserve 3 of the station 1 so as to supply energy to the terminal 2a.

In a second step E2, the terminal 2a is therefore supplied with energy.

In a third step E3, the first operating mode is activated on a first terminal 2b out of the terminals 2 of the network 4. The first terminal 2b then operates in the first operating mode for the predefined duration.

In a fourth step E4, the first terminal 2b operating in the first operating mode issues an order to activate the first mode to all of the other terminals 2 of the network 4. This activation order is communicated to the other terminals 2 of the network 4 via the communication protocol jointly used by the terminals 2 of the network 4 to communicate with one another.

In a fifth step E5, the other terminals 2 of the network 4 receive the order to activate the first mode, issued in step E4, and then change to operating in the first operating mode. The first operating mode is then activated on all of the terminals 2 of the network 4.

In a sixth step E6, each of the terminals 2 of the network 4 transmits a signal concerning activation of the first operating mode, this signal being a light signal and/or an acoustic signal, so as to alert a technician that the network 4 is able to pair the new terminal 2a to be paired.

In a seventh step E7, the first operating mode is activated on the terminal 2a to be paired.

In a final step E8, the terminal 2a to be paired is therefore paired with the terminals 2 of the network 4. More specifically, the pairing E8 is carried out only if step E7 of activating the first mode of the terminal 2a to be paired is implemented during the activation of the first mode of the first terminal 2b, that is to say for the predefined duration following step E3. Indeed, if step E7 is implemented after the predefined duration following the implementation of step E3, that is to say if the first operating mode is activated on the terminal 2a to be paired after the predefined duration of activation of the first operating mode of the first terminal 2b has expired, the first terminal 2b is no longer operating in the first mode and therefore cannot pair with the new terminal 2a to be paired.

The terminal 2a to be paired with the network 4 is therefore necessarily paired during the activation of the first operating mode of the first terminal 2b.

The pairing is for example confirmed by the transmission of a pairing confirmation signal by the terminal 2a.

All of the terminals 2 of the station 1 that are paired with one another thus form the network 4 of terminals. Each of the terminals 2 of the network 4 is therefore installed within communication range of another terminal 2 of the network 4, that is to say at a distance of 10 to 20 meters. Each of the terminals 2 of the network 4 is therefore able to communicate directly with one or more other terminals 2 of the network 4, via the communication protocol jointly used by the terminals 2 of the network 4.

All of the terminals 2 of the station 1 therefore form a wireless network 4 with a meshed topology, and in which each of the terminals 2 constitutes a node of the network 4. Communication between two terminals 2 of the network 4 therefore takes place through a series of point-to-point links between neighboring terminals 2 of the network 4, data packets being routed by each of the terminals 2, which transit the packet autonomously, step-by-step, to a neighboring terminal 2.

Such a network therefore makes it possible to limit wiring, makes it easier to add a new terminal, and is more resistant to the failure of one of the elements of the network.

If the terminal 2a to be paired has to be installed at a location outside of the geographical area with a predefined radius around one of the terminals 2, it is possible to pair a repeater with the network using the same method as FIG. 2 at a given location, such that the repeater is positioned within range of the terminal 2a and of another repeater of the network 4 or of one of the terminals 2 of the network 4.

Some of the terminals 2 of the network may comprise a network access means for connecting for example to external networks, such as the Internet and/or remote servers. In this case, each of the terminals 2 of the network 4 may transmit and/or receive data from these external networks, via said terminals 2 comprising the network access means. Such Internet access may in particular be used to manage and/or maintain the station 1 remotely.

The pairing method of FIG. 2 may also be used to pair a management and/or maintenance node, for example formed by an industrial computer and/or a smartphone having required authorizations, with the network 4.

Furthermore, such a meshed network 4 facilitates maintenance, with information and/or configurations being able to be transmitted to all of the terminals 2 of the network 4 more reliably.

Such a network 4 of terminals 2 paired with one another in accordance with the pairing method illustrated in FIG. 2 may be used in the context of a method for managing energy delivered by one of the terminals 2 of the station 1 for the purpose of charging an electric vehicle.

One of the challenges for a station of charging terminals, such as the station 1, is the local management of its energy consumption.

Indeed, there are many constraints that hamper the management of energy consumption and increase the magnitude thereof. First of all, supplying energy is an expensive process. Moreover, the network power available on a station such as the station 1, that is to say the amount of power able to be delivered simultaneously by the terminals 2 of the station 1, is often less than the sum of possible powers of each terminal 2 of the station 1, that is to say the sum of the amounts of power able to be delivered individually by each of the terminals 2 of the station 1.

It will be recalled that a power is the amount of energy per unit of time. It is thus known to describe an operation of charging a hybrid and/or electric vehicle using terms relating to power and/or energy.

Lastly, local energy management is essential due to the complexity of storing and producing said energy.

In a first step E9 of the method for managing energy delivered by a terminal 2 of the station 1, an initial configuration of energy management parameters is defined.

More specifically, the initial configuration of energy management parameters makes it possible to define a predefined set of rules and parameters that organize the management of the energy of the station 1.

The initial configuration of energy management parameters thus comprises an energy access priority management protocol for the terminals 2 of the station 1, and a definition of a type of power setpoint to be delivered by each of the terminals 2 of the station 1.

The energy access priority management protocol for the terminals 2 of the station 1 defines the common priority management rules to be complied with by the terminals 2 in order to access energy. More particularly, one example of a rule to be complied with may be a priority allocation of energy depending on the chronological order of requests to supply energy from each terminal 2. As an alternative, the energy access priority management protocol for the terminals 2 may define an arbitration on the basis of data such as energy that has already been delivered by each of the terminals 2 to the vehicles being charged or else the charging time already taken by each of the terminals 2 for the vehicle connected thereto, etc.

The access priority management protocol may also define terminals 2 that have priority for accessing energy.

The type of power setpoint to be delivered by a terminal 2 is static or dynamic. A static type of power setpoint to be delivered means that the terminal 2 delivers a constant power, the value of which is predefined by a static setpoint, for example 150 amperes per phase. On the contrary, a dynamic type of power setpoint to be delivered means that the terminal 2 delivers a power of a variable amount depending on the availabilities of the station 1.

The initial configuration of energy management parameters is formulated locally within the station 1, for example via a management node as defined above, or remotely, for example by way of a remote server and/or Internet server.

In a second step E10, the defined initial configuration is communicated to all of the terminals 2 of the station 1 via the network 4, the meshed topology and wireless communication protocol of which allow improved, faster and more reliable transmissions of information.

In a third step E11, the initial configuration is stored locally by each of the terminals 2 of the network 4 of the station 1, so as to be able to apply it if a vehicle is connected.

In a fourth step E12, a vehicle connects to one of the terminals 2 of the station 1, or disconnects. For example, a vehicle connects to the first terminal 2b or disconnects therefrom.

In a fifth step E13, a requirement in terms of power to be delivered is determined for the first terminal 2b to which or from which the vehicle connected or disconnected in step E12.

The requirement in terms of power to be delivered is an ideal theoretical amount of power that the first terminal 2b should deliver following the connection or disconnection of the vehicle.

If a vehicle has connected, the requirement in terms of power to be delivered is therefore an ideal amount of power that the first terminal 2b should deliver so as to have optimized charging, independently of the conditions of use of the energy available from the station 1. Optimized charging of the vehicle is charging that is as efficient as possible, that is to say as fast as possible depending on the technical features of the terminal 2 and of the vehicle that has connected to said terminal 2.

On the contrary, if a vehicle has disconnected from the terminal 2b, the requirement in terms of power to be delivered is substantially zero, because no vehicle is now connected to the first terminal 2b, which therefore no longer has to deliver any energy.

The requirement in terms of power to be delivered by the first terminal 2b depends on the technical features of the vehicle that has connected to the first terminal 2b, such as the maximum power and/or energy limits permitted by said vehicle to recharge it, the amount of energy and/or power needed by the vehicle to recharge it, and the technical features of the terminal 2b, such as the type of power setpoint to be delivered from the terminal 2b, or the maximum energy and/or power limit able to be delivered by the terminal 2b.

In a sixth step E14, the first terminal 2b to which or from which the vehicle connected or disconnected in step E13 recovers energy usage data from the other terminals 2 of the station 1 via the network 4.

More specifically, the first terminal 2b sends a signal concerning connection or disconnection 10 vehicle to the other terminals 2, which respond thereto by transmitting their respective energy usage data thereto.

The energy usage data of a terminal 2 of the station correspond to the amount of energy and/or power delivered by said terminal 2. These data may therefore be neglected when no vehicle is connected to said terminal 2, and are equal to the amount of power and/or power currently being used to charge a vehicle connected to said terminal 2.

In a seventh step E15, a power available to be delivered by the first terminal 2b to which or from which the vehicle has connected or disconnected is determined. The power available to be delivered is the maximum amount of power that the first terminal 2b is able to deliver to the vehicle to recharge it.

This term of power available to be delivered by the first terminal 2b is determined on the basis of the energy usage data of each of the terminals 2 of the station, received in step E14, the initial configuration of the energy management parameters, defined in step E9 and stored locally by the first terminal 2b, and the requirement in terms of power to be delivered by the first terminal 2b, determined in step E13.

Preferably, this term of power available to be delivered by the first terminal 2b is determined directly by the first terminal 2b.

If step E12 corresponds to connection of the vehicle to the first terminal 2b and the energy reserve of the station 1 allows, the power available to be delivered by the first terminal 2b is set to the level of the requirement in terms of power to be delivered, determined in step E13. Otherwise, the power available to be delivered is set to a lower level.

If step E12 corresponds to disconnection of the vehicle from the first terminal 2b, the term of power available to be delivered is substantially negligible and therefore zero.

In a following step E16, a term of corrected power to be delivered is determined for each of the other terminals 2 of the station 1. More specifically, a corrected power to be delivered is determined for each of the other terminals 2 of the station 1 currently delivering energy, that is to say to which a vehicle is connected, the terminals to which no vehicle is connected delivering substantially no energy.

The corrected power to be delivered for a terminal 2 delivering power is determined on the basis of the power available to be delivered by the first terminal 2b, the energy usage data of each terminal 2, recovered in step E14, and the defined initial configuration.

The corrected power to be delivered for a terminal 2 delivering power is preferably determined by the first terminal 2b, in order to limit communications within the network 4.

More specifically, the first terminal 2b determines, for each of the terminals 2 delivering energy, a corrected power to be delivered on the basis of the energy that it is able to deliver to the vehicle, defined by the power available to be delivered by the first terminal 2b, the energy initially delivered by said terminals 2, defined by the energy usage data of these terminals 2, and the initial configuration, and in particular the energy access priority management protocol.

The corrected power to be delivered for a terminal 2 therefore makes it possible to adapt the amount of energy and/or power allocated to the terminal 2 and delivered by this terminal 2 to the new delivery of energy and/or power for the first terminal 2b. The corrected power to be delivered for a terminal 2 is therefore equal to or greater than the power delivered by said terminal 2 before step E12 when step E12 is a step of disconnecting a vehicle from the first terminal 2b, and is therefore less than or equal to the power delivered by said terminal 2 before step E12 when step E12 is a step of connecting a vehicle to the first terminal 2b.

In a following step E17, each terminal 2 of the network 4 of the station 1 recovers its corrected power to be delivered, determined in step E16, and then applies it in a step E18, and transmits a confirmation of application of the term of corrected power to be delivered to the first terminal 2b in a following step E19.

Finally, in a final step E20, the first terminal 2b, having received the confirmations of application of the term of corrected power to be delivered from each of the other terminals 2 of the station 1, charges the vehicle on the basis of the power available to be delivered, determined in step E15.

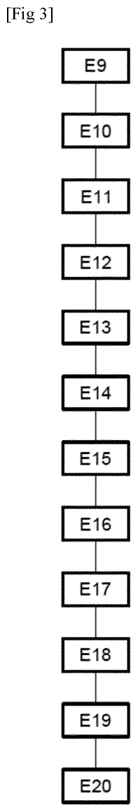

The method of FIG. 3 is thus repeated each time a vehicle is connected to or disconnected from one of the terminals of the station 1. The method thus allows improved energy management for the station 1, because this is decentralized. Indeed, it is not necessary in this method to have a central energy management center, this management being carried out directly by each of the terminals of the station 1 via the network 4.

1. A method for pairing a charging terminal for charging an electric vehicle or a repeater with a communication network of at least one charging terminal comprising the following steps:
installing the charging terminal to be paired in a geographical area around a charging terminal of the network with a radius smaller than a predefined maximum distance between two charging terminals of the network,
supplying energy to the charging terminal to be paired,
activating a first operating mode on a first terminal of the network, the first mode remaining activated for a predefined duration,
the first terminal of the network issuing an order to activate the first operating mode to the other terminals of the network if the network comprises other charging terminals,
activating the first operating mode of the other terminals of the network after receipt of the activation signal,
the other terminals of the network transmitting a signal concerning activation of the first operating mode,
activating the first operating mode on the charging terminal to be paired during the activation of the first operating mode on the first terminal of the network,
pairing the terminal to be paired and the terminals of the network the pairing being carried out during the activation of the first mode on all of the terminals of the network and the terminal to be paired.

2. The pairing method as claimed in claim 1, wherein the paired terminals are configured to detach from the network in a second operating mode.

3. The pairing method as claimed in claim 1, wherein the pairing of a repeater with the network is identical to the pairing of a charging terminal.

4. The method as claimed in claim 1, wherein the predefined duration is 60 seconds.

5. The method as claimed in claim 1, wherein the activation signal is an acoustic signal or a light signal.

6. The method as claimed in claim 1, wherein the predefined maximum distance between two charging terminals of the network is ten to fifteen meters.

7. A communication network between one or more electric charging terminals the terminals being paired with one another in accordance with claim 1, the network being a meshed network.

8. A method for managing energy delivered by a charging terminal of a station of charging terminals for electric vehicles, the terminals of the station being paired in accordance with claim 1 and forming a communication network that is between the charging terminals and is a meshed network, comprising the following steps:
determining an initial configuration of energy management parameters,
communicating the initial configuration to all of the terminals of the station via the network,
each terminal of the network locally storing the initial configuration,
connecting or disconnecting an electric vehicle to or from a first terminal of the station,
determining a requirement in terms of power to be delivered from the first terminal,
the first terminal recovering energy usage data from the other terminals of the station via the network,
determining a power available to be delivered by the first terminal on the basis of the determined requirement in terms of power to be delivered, the recovered energy usage data and the defined initial configuration,
determining a corrected power to be delivered, to be applied by each of the other terminals of the station delivering power, on the basis of the determined power available to be delivered by the first terminal the recovered energy usage data and the defined initial configuration,
the other terminals of the station recovering their corrected power to be delivered and the power available to be delivered by the first terminal the other terminals of the station applying their recovered corrected power to be delivered,
transmitting, to the first terminal a confirmation of application of the corrected power to be delivered by each of the other terminals of the station,
the first terminal charging the electric vehicle on the basis of the determined power available to be delivered, where applicable.

9. The method as claimed in claim 8, wherein the energy management parameters forming the initial configuration comprise a type of power setpoint to be delivered by each of the terminals and an energy access priority management protocol for the terminals of the station.

10. The method as claimed in claim 9, wherein the type of power setpoint to be delivered is static or dynamic.
